(19) United States
(12) Patent Application Publication
(10) Pub. No.: US 2014/0008331 A1
(43) Pub. Date: Jan. 9, 2014

(54) HOT-WIRE CONSUMABLE INCAPABLE OF SUSTAINING AN ARC

(71) Applicant: LINCOLN GLOBAL, INC., City of Industry, CA (US)

(72) Inventor: Jonathan S. OGBORN, Concord Twp., OH (US)

(21) Appl. No.: 13/798,060

(22) Filed: Mar. 12, 2013

Related U.S. Application Data
(60) Provisional application No. 61/668,849, filed on Jul. 6, 2012.

(51) Int. Cl. B23K 3/053; B23K 35/02

(52) U.S. Cl. CPC B23K 3/053; B23K 35/0227
USPC 219/85.14; 219/145.1

(57) ABSTRACT

A system and method for using filler wire in hot wire applications, e.g., brazing, cladding, building up, filling, overlaying, welding, and joining applications, is provided. The filler wire has a first section that has a first resistance per unit length. The filler wire has a second section that has a second resistance per unit length, which is higher than the first resistance per unit length. The second section of the filler wire is configured to melt before the first section during hot-wire applications. In some embodiments, a resistivity of the first section and a resistivity of the second section are equal and the second section has a cross-sectional area that is smaller than a cross-sectional area of the first section. In some embodiments, a resistivity of filler material in the first section and a resistivity of filler material in the second section are different.

### PRIORITY

The present application claims priority to U.S. Provisional Patent Application No. 61/668,849 filed Jul. 6, 2012, which is incorporated herein by reference in its entirety.

### TECHNICAL FIELD

Certain embodiments relate to a filler wire used in overlaying, welding, and joining applications. More particularly, certain embodiments relate to a system and method that uses a filler wire of varying resistance in a system for any of brazing, cladding, building up, filling, hard-facing overlaying, joining, and welding applications.

### BACKGROUND

The traditional filler wire method of welding (e.g., a gas-tungsten arc welding (GTAW) filler wire method) can provide increased deposition rates and welding speeds over that of traditional arc welding alone. In such welding operations, the filler wire, which leads a torch, can be resistance-heated by a separate power supply. The wire is fed through a contact tube toward a workpiece and extends beyond the tube. The extension is resistance-heated to aid in the melting of the filler wire. A tungsten electrode may be used to heat and melt the workpiece to form the weld puddle. A power supply provides a large portion of the energy needed to resistance-melt the filler wire. In some cases, the wire feed may slip or falter and the current in the wire may cause an arc to occur between the tip of the wire and the workpiece. The extra heat of such an arc may cause burnthrough and spatter resulting in poor weld quality.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use at least one filler wire of varying resistance in a system for any of brazing, cladding, building up, filling, hard-facing overlaying, welding, and joining applications. The filler wire has a first section that has a first resistance per unit length. The filler sire also has a second section that has a second resistance per unit length, which is higher than the first resistance per unit length. The second section of the filler wire is configured to melt before the first section during hot-wire applications. In some embodiments, a resistivity of the first section and a resistivity of the second section are equal and the second section has a cross-sectional area that is smaller than a cross-sectional area of the first section. In some embodiments, a resistivity of filler material in the first section and a resistivity of filler material in the second section are different.

The method also includes applying energy from a high intensity energy source to the workpiece to heat the workpiece at least while using a laser to heat the at least one filler wire. The high intensity energy source may include at least one of a laser device, a plasma arc welding (PAW) device, a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying, welding, and joining applications;

FIGS. 2A-C illustrate exemplary embodiments of filler wires that can be used in the system of FIG. 1; and

FIG. 3 illustrates a functional schematic block diagram of an exemplary embodiment of a combination filler wire feeder and energy source system for any of brazing, cladding, building up, filling, hard-facing overlaying, welding, and joining applications.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Like reference numerals refer to like elements throughout.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. This is also true for cladding/surfacing operations, which use similar technology. It is noted that although much of the following discussions will reference “welding” operations and systems, embodiments of the present invention are not just limited to joining operations, but can similarly be used for cladding, brazing, overlaying, etc.—type operations. Furthermore, there is a need to provide systems that can weld quickly under adverse environmental conditions, such as in remote work sites. As described below, exemplary embodiments of the present invention provide significant advantages over existing welding technologies. Such advantages include, but are not limited to, reduced total heat input resulting in low distortion of the workpiece, very high welding travel speeds, very low spatter rates, welding with the absence of shielding, welding plated or coated materials at high speeds with little or no spatter and welding complex materials at high speeds.

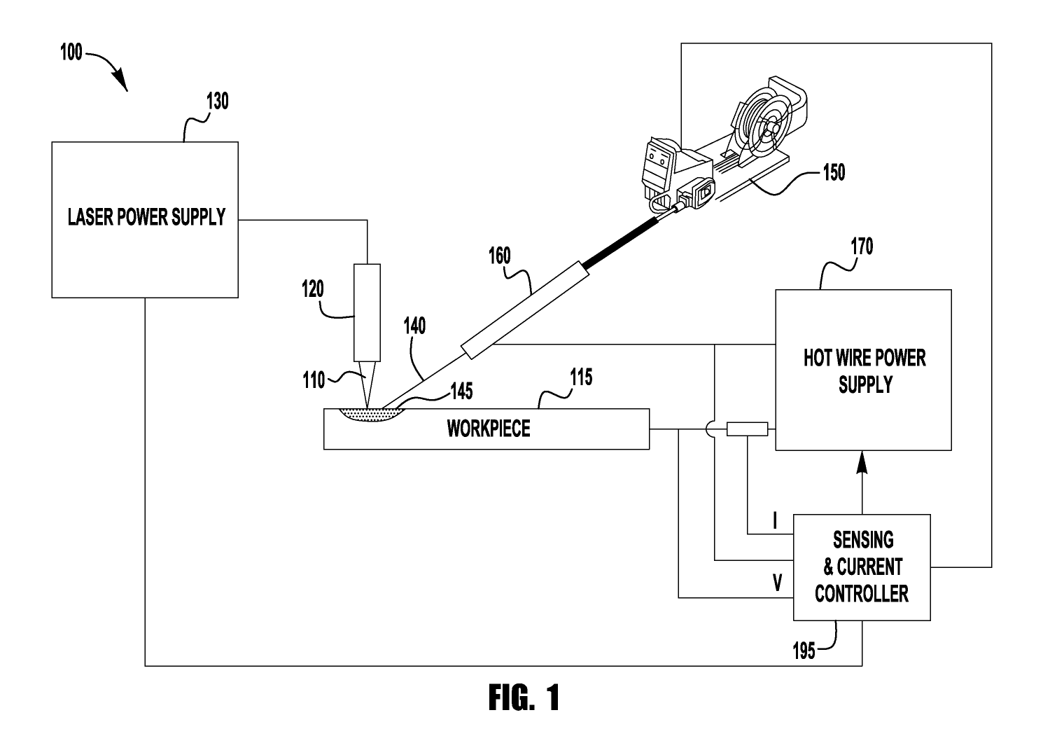

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a high energy heat source capable of heating the workpiece 115 to form a weld puddle 145. The high energy heat source can be a laser subsystem 130/120 that includes a laser device 120 and a weld puddle laser power supply 130 operatively connected to each other. The laser 120 is capable of focusing a laser beam 110 onto the workpiece 115 and the power supply 130 provides the power to operate the laser device 120. The laser subsystem 130/120 can be any type of high energy laser source, including but not limited to carbon dioxide, Nd:YAG, Yb-disk, YB-fiber, fiber delivered, or direct diode laser systems. Further, even white light or quartz laser type systems can be used if they have sufficient energy. For example, a high intensity energy source can provide at least 500 W/cm².

The following specification will repeatedly refer to the laser subsystem 130/120, beam 110 and weld puddle laser power supply 130, however, it should be understood that this reference is exemplary as any high intensity energy source may be used. For example, other embodiments of the high energy heat source may include at least one of an electron beam, a plasma arc welding subsystem, a gas tungsten arc welding subsystem, a gas metal arc welding subsystem, a flux cored arc welding subsystem, and a submerged arc welding subsystem. It should be noted that the high intensity energy sources, such as the laser device 120 discussed herein, should be of a type having sufficient power to provide the necessary energy density for the desired welding operation. That is, the laser device 120 should have a power sufficient to create and maintain a stable weld puddle throughout the welding process, and also reach the desired weld penetration. For example, for some applications, lasers should have the ability to “keyhole” the workpieces being welded. This means that the laser should have sufficient power to fully penetrate the workpiece, while maintaining that level of penetration as the laser travels along the workpiece. Exemplary lasers should have power capabilities in the range of 1 to 20 kW, and may have a power capability in the range of 5 to 20 kW. Higher power lasers can be utilized, but can become very costly.

The system 100 also includes a hot filler wire feeder subsystem capable of providing at least one resistive filler wire 140 to make contact with the workpiece 115 in the vicinity of the laser beam 110. Of course, it is understood that by reference to the workpiece 115 herein, the molten puddle, i.e., weld puddle 145, is considered part of the workpiece 115, thus reference to contact with the workpiece 115 includes contact with the puddle 145. The hot filler wire feeder subsystem includes a filler wire feeder 150, a contact tube 160, and a hot wire power supply 170. During operation, the filler wire 140 is resistance-heated by an electrical current from the hot wire welding power supply 170, which is operatively connected between the contact tube 160 and the workpiece 115. Prior to its entry into the weld puddle 145 on the workpiece 115, the extended portion of the filler wire 140 is heated by the current from the power supply 170 such that the wire 140 approaches or reaches its melting point before contacting the weld puddle 145. Unlike most welding processes, the present invention melts the filler wire 140 into the weld puddle 145 rather than using a welding arc to transfer the filler wire 140 into the weld puddle 145. Because the filler wire 140 is heated to at or near its melting point, its presence in the weld puddle 145 will not appreciably cool or solidify the puddle 145 and the wire 140 is quickly consumed into the weld puddle 145.

In accordance with an embodiment of the present invention, the hot wire welding power supply 170 is a pulsed direct current (DC) power supply, although alternating current (AC) or other types of power supplies are possible as well. The wire 140 is fed from the filler wire feeder 150 through the contact tube 160 toward the workpiece 115 and extends beyond the tube 160. The extension portion of the wire 140 is resistance-heated such that the extension portion approaches or reaches the melting point before contacting the weld puddle 145 on the workpiece 115. The laser beam 110 serves to melt some of the base metal of the workpiece 115 to form the weld puddle 145 and may also help melt the wire 140 onto the workpiece 115. The power supply 170 provides a large portion of the energy needed to resistance-melt the filler wire 140.

Because no welding arc is needed to transfer the filler wire 140 in the process described herein, the feeder subsystem 150 may be capable of simultaneously providing one or more wires, in accordance with certain other embodiments of the present invention. For example, a first wire may be used for hard-facing and/or providing corrosion resistance to the workpiece, and a second wire may be used to add structure to the workpiece. In addition, by directing more than one filler wire to any one weld puddle, the overall deposition rate of the weld process can be significantly increased without a significant increase in heat input. Thus, it is contemplated that open root weld joints can be filled in a single weld pass.

Of course, the melting temperature of the filler wire 140 will vary depending on the size and chemistry of the wire 140. Accordingly, the desired temperature of the filler wire during welding will vary depending on the wire 140. The desired operating temperature for the filler wire 140 can be a data input into the welding system so that the desired wire temperature is maintained during welding. In any event, the temperature of the wire 140 should be such that the wire 140 is consumed into the weld puddle 145 during the welding operation.

As discussed above, the filler wire 140 is melted into the weld puddle 145 without an arc. Traditionally, the filler wire has a constant cross-sectional area over the length of the wire. This allows for uniform heating of the extension portion of wire 140 prior to its entry into the weld puddle 145. However, an arc may inadvertently form if filler wire 140 loses contact with the weld puddle 145 due to overheating or if the wire feed 150 slips or falters as it feeds wire 140 to the weld puddle 140. Such arcs are detrimental to welding process as it may adversely affect weld quality due to burnthrough and splatter. Typically, control units with complicated algorithms are used to predict and control the current through the filler wire 140 in order to prevent such loss of contact. The present invention, however, uses filler wire of varying resistance to prevent (or least minimize) arcing between the wire 140 and workpiece 115. Nevertheless, some embodiments of the present invention can be used in combination with such prediction and control algorithms. Application Ser. No. 13/212,025, titled “Method And System To Start And Use Combination Filler Wire Feed And High Intensity Energy Source For Welding” and incorporated by reference in its entirety, provides exemplary prediction and control algorithms that may be incorporated in sensing and control unit 195 for sensing when the wire 140 is about to lose contact with the workpiece 115.

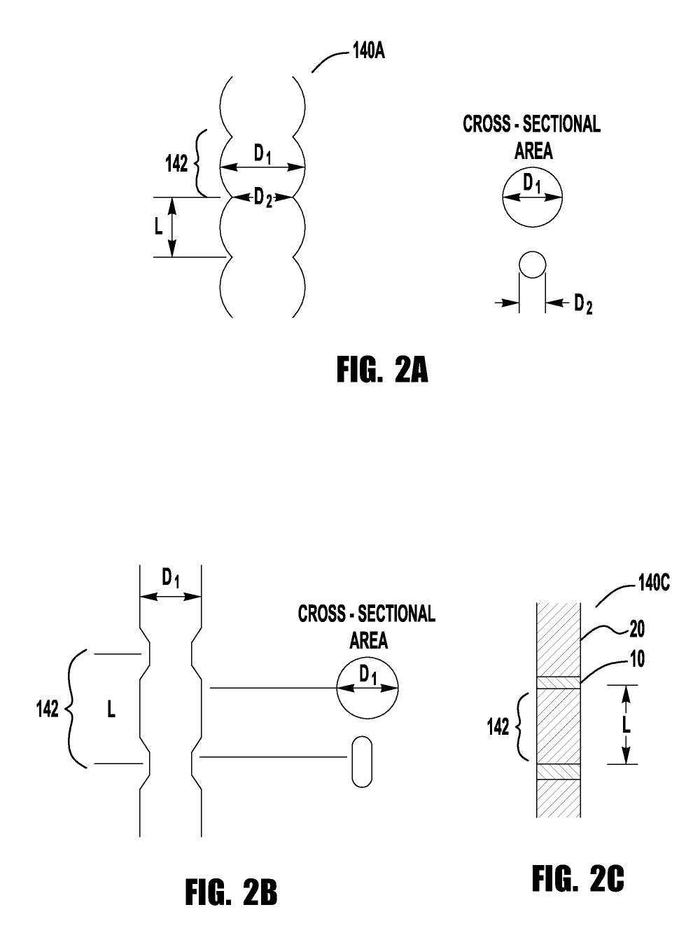

By varying the resistance of filler wire 140, certain portions of wire 140 will heat faster than other portions when the heating current from power supply 170 begins to flow through the wire 140. FIG. 2A illustrates an embodiment of a filler wire 140A that can be used in the system of FIG. 1. Filler wire 140A provides the filler material for the welding process and may be coated with (or include materials) such as flux. The filler wire 140A has a varying outer diameter that ranges from a maximum of D₁ to a minimum of D₂. Thus, the cross-sectional area of filler wire 140A will vary from a maximum value at D₁ to a minimum value at D₂. The diameter D₁ can be in a range, e.g., between 0.030 to 0.095. That is, the diameter D1 can be a standard filler wire diameter, e.g., 0.030 in, 0.045 in, 0.052 in, 0.063 in, 0.068 in, etc. Of course, filler wire 140A can have other diameters based on filler wire properties and the welding system. As discussed further below, diameter D₂ will depend on the desired power level for melting filler wire 140A at location D₂.

Assuming a resistivity (p) for the filler material, the resistance (R) for any given length (l) along wire 140 is R =(ρ*I)/A, where A is the cross-sectional area (i.e., A=π/4*D²). From this equation, one can see that the resistance (R) is inversely proportional to the cross-sectional area and proportional to the length (l). That is, for a given length (l) of the filler wire 140A, the resistance will increase as the cross-sectional area decreases, and for a given cross-sectional area (A), the resistance (R) will increase as length (I) increases. Accordingly, at location D₁ on wire 140A, the resistance R₁=(ρ*l)/(π/4*D₁²); and at location D₂ on wire 140A, the resistance R₂=(ρ*l)/(π/4*D₂²).

Therefore, if the resistivity (ρ) of the filler material is assumed to be uniform, the resistance per unit length of the filler wire 140A will be at its minimum at diameter D₁ and increase to its maximum at diameter D₂. Because the resistance per unit length of the filler wire 140A is at its highest at diameter D₂, the resistance heating of filler wire 140A will melt at that location first due to the resistive heating current flowing through the wire 140A. In exemplary embodiments, the diameter D₂ is selected such that the filler wire 140A will melt at location D₂ at a power that is 75-95% of the power value needed to melt the filler wire 140A at location D₁. Of course, in determining the diameter D₂, the change in resistance of filler wire 140 due to temperature (because of the heating current) may need to be taken into account.

Thus, during the welding process, power supply 170 will only need to supply 75-95% of the power typically needed for the standard filler wire to melt the filler wire 140 at the location D₂ and for a small amount of filler material, i.e., filler section 142, to go into the weld puddle 145. Because filler section 142 melts off into the weld puddle 145 at a reduced power level, the likelihood of creating an arc between filler wire 140A and workpiece 115 is reduced. In some embodiments, at least a portion of the filler section 142 can be solid as it enters the weld puddle 145 before the weld puddle 145 melts and absorbs the filler section 142.

In some exemplary embodiments, the laser device 120 can facilitate the melting of the filler section 142 because laser 120 allows for precise control of the weld puddle 145, including easy adjustments of the size and depth of the weld puddle 145. These adjustments are possible because the laser beam 110 can be focused/de-focused easily or have its beam intensity changed very easily. Because of these abilities, the heat distribution on the workpiece 115 can be precisely controlled. This control allows for the creation of a weld puddle 145 that can accept an un-melted (or partially melted) filler section 142 and melt it. In exemplary embodiments of the present invention, the shape and/or intensity of the beam 110 can be adjusted/changed during the welding process to ensure the weld puddle 145 completely melts the filler section 142. For example, during the welding process, it may be necessary to change the depth of penetration or to change the size of the weld bead in order to melt the filler section 142. In such embodiments, the shape, intensity, and/or size of the beam 110 can be adjusted during the welding process to provide the needed change in the welding parameters.

As described above, the filler section 142 impacts the same weld puddle 145 as the laser beam 110. In some exemplary embodiments, the filler section 142 can impact the same weld puddle remotely from the laser beam 110. However, in other exemplary embodiments, the filler section 142 impacts the weld puddle 145 at the same location as the laser beam 110. In such embodiments, the laser beam 110 itself can be used to aid in the melting of filler section 142. However, because many filler wires are made of materials which can be reflective, if a reflective laser type is used the wire should be heated to a temperature such that its surface reflectivity is reduced, allowing the beam 110 to contribute to the heating/melting of the filler section 142. In exemplary embodiments of this configuration, the filler section 142 and beam 110 intersect at the point at which the filler section 142 enters the puddle 145.

For any given filler wire diameter, the size of the filler section 142 will be determined by the length L, which is the distance between locations D₂. Accordingly, along with parameters such as wire speed, the length L will aid in determining the rate of deposit of the filler material during the operation. The length L of the filler section 142 may be determined based on factors such as the type of filler material, the type of welding to be performed, and the temperature of the weld puddle 145—to name just a few. For example, in some exemplary embodiments, the length L is at least as long as the diameter D₁. In further exemplary embodiments, the length L is in the range of −25 to +25% of the diameter D₁. The ranges of length L in relation to diameter Dare based on resistance of the filler sections at room temperature. In an exemplary embodiment, the filler wire 140A may be manufactured by crimping the circumference of a standard filler wire to achieve diameter D₂. In some embodiments, the filler wire 140A may be pre-crimped at the factory. In other embodiments, the filler wire 140A is crimped by, for example wire feeder 150, as wire 140A is being fed to weld puddle 145. That is, the wire feeder 150 (or some other mechanical device) crimps the wire 140 as it is fed to the operation. Such devices can use a compressive force to crimp the wire 140 as desired. In such an embodiment, the length L can be a user input to sensing and control unit 195 (see FIG. 1), which can control wire feeder 150 and the crimping operation consistent with the input data. Alternatively, in other exemplary embodiments the length L can be automatically adjusted by sensing and control unit 195 based on welding conditions. For example, the wire feeder 150 can contain a torque sensor (or something similar) which senses that the wire 140 is contacting the bottom of the weld puddle and based on feedback from this sensor the length L and/or the heating current can be changed to ensure proper operation and melting of the wire 140 in the puddle. Of course, these functions (i.e., the user input and automated control of length L) may be incorporated into wire feeder 150 or other suitable components.

In the above embodiments, the filler wire 140A has a circular cross-sectional area that varies from D₁ and D₂. However, the present invention is not limited to just this geometry. For example, in FIG. 2B, the filler wire 140B is formed by notching the filler wire 140B on opposite sides of the wire 140. Of course, the present invention is not limited by the shape of the cross-section of the filler wire 140 and any number of different cross-sectional shapes can be used as long as there is a variation in the cross-sectional areas in the filler wire. It is this variation in cross-sectional area which changes the resistivity between the sections. Further, although the filler section 142 is illustrated as approximating a sphere in FIG. 2A, the shape of the filler section 142 is not limiting. For example, in FIG. 2B, the filler section 142 is illustrated as approximating a cylinder with a diameter of approximately D₁ along filler section 142. However, in general, filler shapes that optimize the melting of the section 142 in the weld puddle 145 are desired. As in the above embodiments, the filler wire 140B may be pre-notched at the factory or by wire feeder 150 (or similar components) during the welding process.

In the above embodiments, the variation in resistance in filler wires 140A and 140B is accomplished by changing the cross-section of the filler wire 140. However, the present invention is not limited to just changing the cross-sectional areas. In some exemplary embodiments of the present invention, the cross-section of the filler wire may remain constant and the resistivity is varied by changing the density of the filler materials in the filler wire 140C as illustrated in FIG. 2C. In FIG. 2C, filler material in portion 10 of filler wire 140C has a higher resistivity (ohm-meter) (for example, due to a lower density) than in portion 20. Thus, for a given cross-sectional area and filler material, portion 10 will have a higher resistance per unit length and will melt faster than portion 20. Alternatively, or in addition to, the filler material in portion 10 can be of a different material composition (and resistivity) than in portion 20. Thus, embodiments of the present invention can use a wire 140 having various densities, construction, shape, and/or material composition along its length which varies the resistivity of the wire 140 along its length. Such a construction allows for the use of a lower heating current which can aid in avoiding the creation of a welding arc.

In exemplary embodiments of the present invention, the portions 142 have a resistance per unit length that is in the range of 5 to 45% lower than that of portions D₂, 10. In other exemplary embodiments, the difference is in the range of 5 to 25%. The above ranges are based on resistance values of the filler sections at room temperature.

In the above exemplary embodiments, the filler wire is assumed to be solid. However, the same principles apply to a cored filler wire (metal or flux cored), or flux coated wires. In fact, embodiments of the present invention can use the flux (either cored or coated flux) to vary the resistance of the wire 140. That is, the present invention includes embodiments where a solid wire core or sheath is used having consistent properties—consistent with arc welding consumables, where the shape, geometry and/or chemistry of a flux secured to selected portions of the metal part of the wire 140 changes the resistance of the wire 140 at those portions.

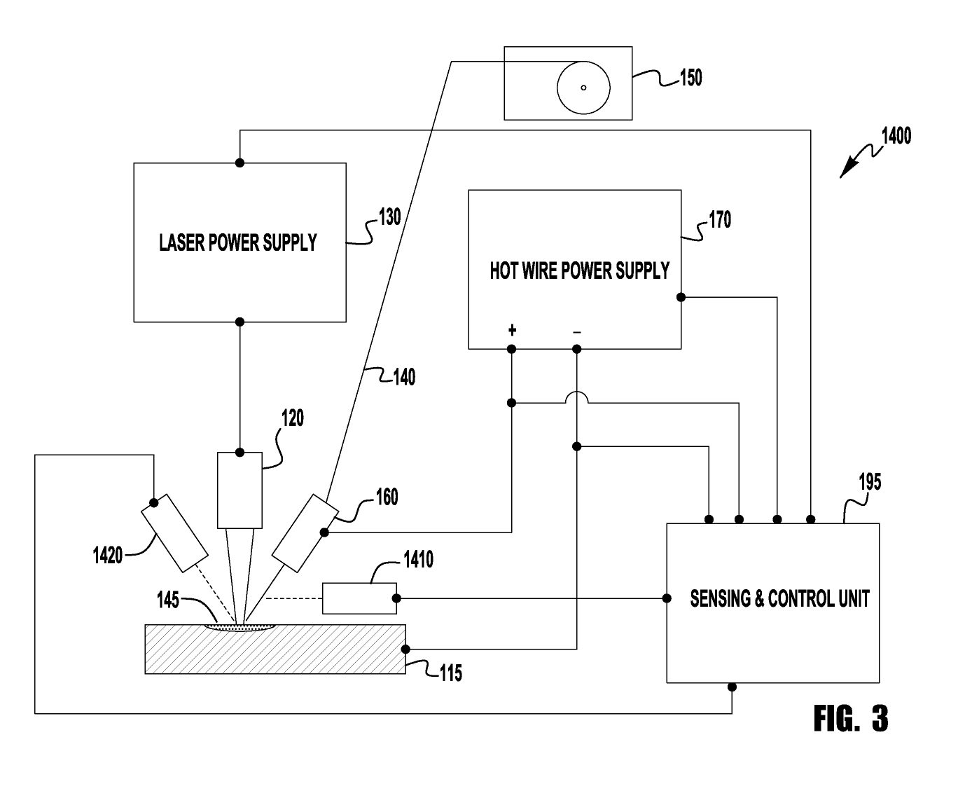

FIG. 3 depicts yet another exemplary embodiment of the present invention. FIG. 3 shows an embodiment similar to that as shown in FIG. 1. However, certain components and connections are not depicted for clarity. FIG. 3 depicts a system 1400 in which a thermal sensor 1410 is utilized to monitor the temperature of the wire 140. The resistance of filler wire 140 varies as discussed above and, in some embodiments, can be any one of the filler wires 140A, 140B, and 140C. The thermal sensor 1410 can be of any known type capable of detecting the temperature of the wire 140. The sensor 1410 can make contact with the wire 140 or can be coupled to the tip 160 so as to detect the temperature of the wire. In a further exemplary embodiment of the present invention, the sensor 1410 is a type which uses a laser or infrared beam which is capable of detecting the temperature of a small object—such as the diameter of a filler wire—without contacting the wire 140. In such an embodiment the sensor 1410 is positioned such that the temperature of the wire 140 can be detected at the stick out of the wire 140—that is at some point between the end of the tip of contact tube 160 and the weld puddle 145. The sensor 1410 should also be positioned such that the sensor 1410 for the wire 140 does not sense the temperature of weld puddle 145.

The sensor 1410 is coupled to a sensing and control unit 195 such that temperature feed back information can be provided to the power supply 170, the laser power supply 130, and/or wire feeder 150 so that the control of the system 1400 can be optimized. For example, the power or current output of the power supply 170 can be adjusted based on at least the feedback from the sensor 1410. That is, in an embodiment of the present invention either the user can input a desired temperature setting (for a given weld and/or wire 140) or the sensing and control unit 195 can set a desired temperature based on other user input data (filler wire diameter, minimum cross-sectional area of the filler wire, resistivity of filler material, length L of filler droplet, wire feed speed, electrode type, etc.) and then the sensing and control unit 195 would control at least the power supply 170, laser power supply 130, and/or wire feeder 150 to maintain that desired temperature.

In such an embodiment it is possible to account for heating of the wire 140 that may occur due to the laser beam 110 impacting on the wire 140 before the wire 140 enters the weld puddle 145. In embodiments of the invention the temperature of the wire 140 can be controlled only via power supply 170 by controlling the current in the wire 140. However, in other embodiments at least some of the heating of the wire 140 can come from the laser beam 110 impinging on at least a part of the wire 140. As such, the current or power from the power supply 170 alone may not be representative of the temperature of the wire 140. As such, utilization of the sensor 1410 can aid in regulating the temperature of the wire 140 through control of the power supply 170, the laser power supply 130 and/or wire feeder 150.

In a further exemplary embodiment (also shown in FIG. 3) a temperature sensor 1420 is directed to sense the temperature of the weld puddle 145. In this embodiment the temperature of the weld puddle 145 is also coupled to the sensing and control unit 195. However, in another exemplary embodiment, the sensor 1420 can be coupled directly to the laser power supply 130 and/or wire feeder 150. Feedback from the sensor 1420 can be used to control output from laser power supply 130/laser 120. That is, the energy density of the laser beam 110 can be modified to ensure that the desired weld puddle temperature is achieved. The sensor 1420 may also be used to control wire feeder 150. For example, the length of filler droplet 142 (see FIGS. 2A and 2B) may be controlled based on the temperature of weld puddle 145.

In another exemplary embodiment of the present invention, the sensing and control unit 195 can be coupled to a feed force detection unit (not shown) which is coupled to the wire feeder 150. The feed force detection units are known and detect the feed force being applied to the wire 140 as it is being fed to the workpiece 115. For example, such a detection unit can monitor the torque being applied by a wire feeding motor in the wire feeder 150. If the wire 140 passes through the molten weld puddle 145 without fully melting it will contact a solid portion of the workpiece 115 and such contact will cause the feed force to increase as the motor is trying to maintain a set feed rate. This increase in force/torque can be detected and relayed to the control unit 195 which utilizes this information to adjust the heating current from power supply 170 to the wire 140 to ensure proper melting of the wire 140 in the weld puddle 145. This information can also be used to change the length L to the extent any shaping of the wire is conducted during the operation.

In FIGS. 1 and 3 the laser power supply 130, hot wire power supply 170, wire feeder 150, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A filler wire for use in hot-wire applications, said filler wire comprising:
a first section that has a first resistance per unit length; and
a second section that has a second resistance per unit length which is higher than said first resistance per unit length,
wherein said second section is configured to melt before said first section during said hot-wire applications.

2. The filler wire of claim 1, wherein a resistivity of said first section and a resistivity of said second section are equal, and
wherein said second section has a cross-sectional area that is smaller than a cross-sectional area of said first section.

3. The filler wire of claim 2, wherein said second section melts at a power level that is 75% to 95% of a power level required to melt said first section.

4. The filler wire of claim 2, wherein a length of said first section is in a range of −25% to +25% of a diameter of said first section.

5. The filler wire of claim 2, wherein a resistance per unit length of said first section is in a range of 5% to 45% of a resistance per unit length of said second section.

6. The filler wire of claim 1, wherein a resistivity of filler material in said first section and a resistivity of filler material in said second section are different.

7. The filler wire of claim 6, wherein a cross-section area of said second section and a cross-sectional area of said first section are equal.

8. The filler wire of claim 6, wherein a density of said filler material in said second section and a density of said filler material in said first section are different.

9. The filler wire of claim 6, wherein a material composition of said filler material in said second section and a material composition of said filler material in said first section are different.

10. The filler wire of claim 6, wherein said second section melts at a power level that is 75% to 95% of a power level required to melt said first section.

11. The filler wire of claim 6, wherein a resistance per unit length of said first section is in a range of 5% to 45% of a resistance per unit length of said second section.

12. A hot-wire system, said system comprising:
a high intensity heat source that heats at least one workpiece and creates a molten puddle;
a wire feeder that feeds a filler wire to said molten puddle;
a hot wire power supply operatively connected to said filler wire, said hot wire power supply supplying a heating current through said filler wire to heat said filler wire,
wherein said filler wire comprises,
a first section that has a first resistance per unit length, and
a second section that has a second resistance per unit length which is higher than said first resistance per unit length,
wherein said second section is configured to melt before said first section during said hot-wire applications.

13. The hot wire system of claim 12, wherein at least a portion of said first section is solid as said first section enters said molten puddle, and
wherein said molten puddle melts and absorbs said portion of said first section.

14. The hot wire system of claim 13, wherein a resistivity of said first section and a resistivity of said second section are equal, and
wherein said second section has a cross-sectional area that is smaller than a cross-sectional area of said first section.

15. The hot wire system of claim 14, wherein said heating current melts said second section at a power level that is 75% to 95% of a power level required to melt said first section.

16. The hot wire system of claim 12, wherein a resistivity of filler material in said first section and a resistivity of filler material in said second section are different.

17. The hot wire system of claim 16, wherein said heating current melts said second section at a power level that is 75% to 95% of a power level required to melt said first section.

18. A method of using filler wire in a hot-wire system, said method comprising:
heating at least one workpiece to a molten puddle;
feeding a filler wire to said molten puddle;
supplying a heating current to said hot wire power supply to heat said filler wire,
wherein said filler wire comprises,
a first section that has a first resistance per unit length, and
a second section that has a second resistance per unit length which is higher than said first resistance per unit length,
wherein said second section is configured to melt before said first section during said hot-wire applications.

19. The method of claim 18, wherein a resistivity of said first section and a resistivity of said second section are equal, and
wherein said second section has a cross-sectional area that is smaller than a cross-sectional area of said first section.

20. The method of claim 18, wherein a resistivity of filler material in said first section and a resistivity of filler material in said second section are different.
